(19) United States
(12) Patent Application Publication
(10) Pub. No.: US 2015/0034035 A1
(43) Pub. Date: Feb. 5, 2015

(54) ETHANOL-BASED FUEL AND USE THEREOF

(71) Applicant: CATERPILLAR MOTOREN GMBH & CO. KG, Kiel (DE)

(72) Inventors: Jens-Uwe Reeh, Flintbek (DE); Andreas Von Der Osten-Sack, Kiel (DE)

(73) Assignee: CATERPILLAR MOTOREN GMBH & CO. KG, Kiel (DE)

(21) Appl. No.: 14/381,027

(22) PCT Filed: Feb. 8, 2013
(86) PCT No.: PCT/EP2013/000387

§ 371 Date: Aug. 26, 2014

(30) Foreign Application Priority Data
Feb. 28, 2012 (EP) 12 157 275.4

(51) Int. Cl. C10L 10/12; C10L 1/02; F02B 1/02

(52) U.S. Cl. CPC C10L 10/12; F02B 1/02; C10L 1/02; C10L 1/026; C10L 2270/026; C10L 2300/20; C10L 2200/0469
USPC 123/1 A; 44/398

(57) ABSTRACT

An ethanol-based fuel is disclosed that includes 40 to 90% by volume ethanol and 60 to 10% by volume castor oil. The fuel may also include one or more additives in a total amount of up to 10 wt. % of the total weight of the ethanol and castor oil. The ethanol-based fuel may be used for operating an internal combustion engine, and may be used as a switch-over fuel, in between using different fuels that are incompatible with each other.

### TECHNICAL FIELD

The present disclosure refers to an ethanol-based fuel. Furthermore, the present disclosure refers to the use of said ethanol-based fuel for operating an internal combustion engine, for example, a self-ignition internal combustion engine, including the use of said ethanol-based fuel for switching over an internal combustion engine between operation with different fuels.

### BACKGROUND

New fuels replacing fossil fuels are the subject of ongoing interest, in particular with respect to the replacement of diesel fuel, light fuel oil (LFO) or heavy fuel oil (HFO) due to rising oil prices and environmental concerns with increased emissions.

In view of the reduction of green house gas emissions that are believed to contribute to global warming, the selection of fuel types, which are essentially CO₂ neutral, is considered one of the most effective routes. This is the case for fuels made from biomass, as biomass absorbs the same amount of CO₂ during its growing period as it releases when combusted as a fuel.

For example, alcohols have been proposed for this purpose. Alcohols show suitable combustion properties, however, usually cannot be used as such in internal combustion engines due to too low Cetane value and a lack of lubrification properties.

Furthermore, it is also known to mix alcohols, in particular ethanol, with vegetable oils and/or crude oil-based fuels, like diesel fuel, in order to improve the lubrification properties of the alcohol. However, since vegetable oils and diesel fuel are hardly soluble in alcohols or not soluble at all, additives improving the solubility of the vegetable oils or diesel fuel in the alcohol have to be used, which may cause increased emissions.

Researchers also focus on liquid fuels obtained by the pyrolysis of biomass. Liquid biomass fuels can be obtained from the pyrolysis of, for example, wood or agricultural wastes, like straw, etc., and are commonly designated as pyrolysis oils. In general, pyrolysis oil is predominantly produced by the “Fast Pyrolysis” technology, which comprises rapid pyrolyzation of biomass in a fluidized bubbling sand bed reactor, wherein the solid heat-carrying medium is circulated and, therefore, the residence time of solids is well-controlled and high heating rates (up to 1000° C./second) are obtained. The biomass feed and the solid heat-carrying medium are passed through a tubular transport reactor at a temperature in the range of about 450 to 500° C. and in a residence time of less than 1 second.

It is well known that the physical properties and the chemical composition of pyrolysis oils differ significantly from those of diesel fuel, LFO or HFO, in particular with respect to the high content of water and oxygen and with respect to the acidic pH value and the rather low heating value of pyrolysis oils. Moreover, pyrolysis oils, which include polar hydrocarbons and large amounts of water, are almost immiscible with diesel fuel, LFO or HFO, which consist mainly of saturated olefinic and aromatic hydrocarbons. Finally, a further disadvantage of fuels based on pyrolysis oils is their strong corrosion acting on metal parts in the engine system.

The present disclosure is directed, at least in part, to improving or overcoming one or more aspects of the related prior art.

### SUMMARY OF THE DISCLOSURE

According to a first aspect of the present disclosure, an ethanol-based fuel comprises, based on the total volume of ethanol and castor oil, 40 to 90% by volume ethanol and 60 to 10% by volume castor oil, and optionally includes one or more additives in a total amount of up to 10 wt.-% of the total weight of the ethanol and castor oil.

In particular, the ethanol-based fuel consists of, based on the total volume of ethanol and castor oil, 40 to 90% by volume ethanol and 60 to 10% by volume castor oil, and optionally includes one or more additives in a total amount of up to 10 wt.-% of the total weight of the ethanol and castor oil.

According to a second aspect of the present disclosure, the ethanol-based fuel is used for operating an internal combustion engine, for example, a self-ignition internal combustion engine.

Other features and aspects of this disclosure will be apparent from the following description and the claims.

### DETAILED DESCRIPTION

The following is a detailed description of exemplary embodiments of the present disclosure. The exemplary embodiments described therein are intended to teach the principles of the present disclosure, enabling those of ordinary skill in the art to implement and use the present disclosure in many different environments and for many different applications. Therefore, the exemplary embodiments are not intended to be, and should not be considered as, a limiting description of the scope of patent protection. Rather, the scope of patent protection shall be defined by the appended claims.

According to a first aspect of the present disclosure, an ethanol-based fuel may comprise, based on the total volume of ethanol and castor oil, 40 to 90% by volume ethanol and 60 to 10% by volume castor oil, and optionally include one or more additives in a total amount of up to 10 wt.-% of the total weight of the ethanol and castor oil.

In particular, the ethanol-based fuel may consist of, based on the total volume of ethanol and castor oil, 40 to 90% by volume ethanol and 60 to 10% by volume castor oil, and optionally include one or more additives in a total amount of up to 10 wt.-% of the total weight of the ethanol and castor oil.

The ethanol to be used in the present ethanol-based fuel is not specifically restricted. However, in view of CO₂ neutrality it may be preferred to use ethanol from biological sources, like for example ethanol produced from feedstocks like sugar cane, bagasse, miscanthus, sugar beet, sorghum, grain, switchgrass, barley, hemp, kenaf, potatoes, cassava, sunflower, fruit, molasses, corn, wheat, straw, cotton and cellulose waste and harvestings.

The term “ethanol” as used herein and in the appended claims comprises both absolute ethanol (i.e. ethanol containing less than 0.5% by volume water) and ethanol containing considerable amounts of water. In the latter case, the water content of the ethanol may range from 0.5 to 6% by volume, preferably from 2 to 5% by volume, in particular from 3 to 4% by volume. For economic reasons, the use of ethanol containing considerable amounts of water may be preferred.

The castor oil to be used in the present ethanol-based fuel is a vegetable oil obtained from castor seed of the castor plant Ricinus communis, which is a colorless to very pale yellow liquid having a mild or no odor or taste. Ricinoleic acid, which is the main fatty acid chain of castor oil (85 to 95 wt.-%), has a hydroxyl group at C₁₂, which provides the fatty acid chain with polar properties, promoting solubility in polar liquids like ethanol. At the same time, the remaining non-polar hydrocarbon chain of ricinoleic acid still provides sufficient non-polar character, such that castor oil is miscible with non-polar liquids, like, for example, diesel fuel, LFO, or HFO.

The term “consists of” or “consisting of” used in the present application in the context of the ethanol-based fuel means that merely unavoidable impurities are allowed to be present in the ethanol-based fuel besides the indicated compulsory and optional components.

According to exemplary embodiments of the present disclosure, the ethanol content may be 40 to 80% by volume and the castor oil content may be 60 to 20% by volume, or the ethanol content may be 42 to 78% by volume and the castor oil content may be 58 to 22% by volume, or the ethanol content may be 45 to 65% by volume and the castor oil content may be 55 to 35% by volume, or the ethanol content may be 45 to 55% by volume and the castor oil content may be 55 to 45% by volume, or the ethanol content may be 48 to 52% by volume and the castor oil content may be 52 to 48% by volume, or the ethanol content may be 50% by volume and the castor oil content may be 50% by volume.

For economical reasons, the ethanol content of the ethanol-based fuel may be as high as possible, for example 60 to 90% by volume, or 70 to 90% by volume, or 80 to 90% by volume, or 82 to 90% by volume, or 85 to 90% by volume, in particular if the ethanol-based fuel is used for continuous (long-time) operation of an internal combustion engine, preferably a self-ignition internal combustion engine.

In case the present ethanol-based fuel is to be used for switching over an internal combustion engine between operation with different fuels, which is explained in more detailed below, the ethanol content may be 45 to 65% by volume and the castor oil content may be 55 to 35% by volume, or the ethanol content may be 45 to 55% by volume and the castor oil content may be 55 to 45% by volume, or the ethanol content may be 48 to 52% by volume and the castor oil content may be 52 to 48% by volume, or the ethanol content may be 50% by volume and the castor oil content may be 50% by volume.

According to an exemplary embodiment of the present disclosure, the ethanol-based fuel disclosed herein optionally may include one or more additives in a total amount of up to 10 wt.-% of the total weight of the ethanol and castor oil, preferably in a total amount of up to 5 wt.-%, preferably in a total amount of up to 3 wt.-%, preferably in a total amount of up to 2 wt.-%, preferably in a total amount of up to 1 wt.-% of the total weight of the ethanol and castor oil.

Said additives may be selected from the group consisting of thermal stabilizers, aging stabilizers, antioxidants, coloring agents, dyes, rust inhibitors, inhibitors of gum formation, metal deactivators, upper cylinder lubricants, friction modifiers, detergents, bacteriostatic agents, fungicides, microbiocides, and mixtures thereof.

The additives optionally included in the ethanol-based fuel disclosed herein may serve to improve one or more properties of the ethanol-based fuel, if considered to be necessary in view of the used engine type or any other circumstances, which require the use of additives. However, in view of environmental concerns (increased emissions), it may be preferred to provide the ethanol-based fuel devoid of any additives.

According to a second aspect of the present disclosure, the ethanol-based fuel disclosed herein may be used for operating an internal combustion engine, for example, a self-ignition internal combustion engine.

The internal combustion engine is not specifically restricted. For example, the ethanol-based fuel disclosed herein may be used with self-ignition internal combustion engines, including low, medium and high speed internal combustion engines, like low speed engines operated with 60 to 250 rpm, medium speed engines of the series M20, M25, M32, M43 manufactured by Caterpillar Motoren GmbH & Co. KG, Kiel, Germany, operated in a range of 500 to 1000 rpm, and high speed engines manufactured by Caterpillar at Mossville Engine Center, Mossville, Ill., USA, operated with more than 1000 rpm.

According to the present invention, continuous (long-time) operation of internal combustion engines, for example, of self-ignition internal combustion engines, with the ethanol-based fuel disclosed herein may provide the advantage of CO₂ neutrality at low operation costs, wherein the ethanol-based fuel simultaneously may provide a high power generation efficiency.

According to an exemplary embodiment of the present disclosure, the use of an ethanol-based fuel, consisting of, based on the total volume of ethanol and castor oil, 40 to 90% by volume ethanol and 60 to 10% by volume castor oil, and optionally including one or more additives in a total amount of up to 10 wt.-% of the total weight of the ethanol and castor oil, for switching over an internal combustion engine between an operation with pyrolysis oil and an operation with a crude oil-based fuel, while continuously operating the internal combustion engine, is provided.

According to specific embodiments of said use, the ethanol content of the ethanol-based fuel is 70 to 90% by volume and the castor oil content is 30 to 10% by volume, or the ethanol content of the ethanol-based fuel is 80 to 90% by volume and the castor oil content is 20 to 10% by volume, or the ethanol content of the ethanol-based fuel is 85 to 90% by volume and the castor oil content is 15 to 10% by volume, or the ethanol content of the ethanol-based fuel is 40 to 80% by volume and the castor oil content is 60 to 20% by volume, or the ethanol content of the ethanol-based fuel is 45 to 65% by volume and the castor oil content is 55 to 35% by volume, or the ethanol content of the ethanol-based fuel is 45 to 55% by volume and the castor oil content is 55 to 45% by volume, or the ethanol content of the ethanol-based fuel is 48 to 52% by volume and the castor oil content is 52 to 48% by volume, or the ethanol content of the ethanol-based fuel is 50% by volume and the castor oil content is 50% by volume.

According to a specific embodiment of said use, the additive is selected from the group consisting of thermal stabilizers, aging stabilizers, antioxidants, coloring agents, dyes, odor modifying agents, rust inhibitors, inhibitors of gum formation, metal deactivators, upper cylinder lubricants, friction modifiers, detergents, bacteriostatic agents, fungicides, microbiocides, and mixtures thereof, and/or wherein the one or more additive(s) is optionally included in a total amount of up to 5 wt.-% or up to 3 wt.-% of the total weight of the ethanol and castor oil.

For example, one may switch over from operating the engine with diesel fuel, LFO or HFO to operating the engine with a pyrolysis oil, or vice versa, in case it is desired to return to an operation with diesel fuel, LFO, or HFO again. However, in case pyrolysis oil is contacted with diesel fuel, LFO, or HFO in the course of switching over from diesel fuel, LFO, or HFO operation to pyrolysis oil operation or vice versa, a precipitation phenomenon may occur frequently due to the mutual incompatibility of pyrolysis oil and diesel fuel, LFO, or HFO, in particular depending on the specific composition of the pyrolysis oil. The resulting precipitates may obstruct ducts and pipes of the engine and associated systems and, thus, may require extensive cleaning operation causing costly downtime of the engine and associated systems. Switching between the fuel types may be performed while continuously operating the engine, by operating the engine with the switch over fuel to clean the engine system from any residues of the previous fuel.

It should be noted that according to the present disclosure said switching over may comprise both switching over from an operation with pyrolysis oil to an operation with a crude oil-based fuel and switching over from an operation with a crude oil-based fuel to an operation with pyrolysis oil.

According to an exemplary embodiment of the present disclosure, the crude oil-based fuel is selected from the group consisting of diesel fuel, light fuel oil (LFO), and heavy fuel oil (HFO). In particular, the crude oil-based fuel is diesel fuel.

The use of pyrolysis oil for operating an internal combustion engine, for example, a self-ignition internal combustion engine, is an environmentally advantageous alternative to operating the same with a crude oil-based fuel, since pyrolysis oil is obtained from renewable sources.

It has been found that switching over from operating an internal combustion engine with a crude oil-based fuel, like for example diesel fuel, LFO or HFO, to operating the engine with a pyrolysis oil and vice versa may be effectively carried out by using the ethanol-based fuel according to the present disclosure.

In the following, said switching over is briefly explained in the context of a self-ignition internal combustion engine operated with diesel fuel. In particular, the switching over process may be carried out by adding the present ethanol-based fuel to the diesel fuel, by which the engine is operated, in a gradual manner, wherein the amount of the ethanol-based fuel may be increased, until the diesel fuel is fully replaced by the present ethanol-based fuel within the engine and its fuel system. Then, the pyrolysis oil may be mixed into the ethanol-based fuel, by which the engine is transiently operated, wherein the amount of pyrolysis oil may be gradually increased, until the ethanol-based fuel is fully replaced by the pyrolysis oil and the engine is finally operated with pyrolysis oil only. By this process, the contact of the diesel fuel with pyrolysis oil is fully avoided or at least to an acceptable extent, such that no or only an acceptable precipitation phenomenon may occur.

Details of a system into which such a self-ignition internal combustion engine may be incorporated as well as of such a switch over process are disclosed, for example, in the applications “SELF IGNITION OPERATION OF ALTERNATIVE FUEL INTERNAL COMBUSTION ENGINES” and “OPERATING A POWER PLANT WITH ALTERNATIVE FUELS” filed on the same day by Caterpillar Motoren GmbH & Co. KG. The contents of those applications are herein incorporated by reference.

### INDUSTRIAL APPLICABILITY

In the following, the basic operation of the above exemplary embodiments of the present disclosure is explained.

### EXAMPLE 1

### Continuous Operation of a Self-Ignition Internal Combustion Engine with an Ethanol-Based Fuel According to the Present Disclosure

The ethanol-based fuel used for continuous operation of a self-ignition internal combustion engine consisted of the following components in a mixing ratio of 50% by volume ethanol and 50% by volume castor oil:

Ethanol: Bioethanol (including 1% by volume water, supplied by CropEnergies AG, Mannheim, Germany)

Castor oil: Castor Oil commercial grade (supplied by Biotor Industries Limited, Markapura, India)

The above-mentioned ethanol-based fuel (50/50 mixture) was tested in a M20 medium speed diesel engine (supplied by Caterpillar Motoren GmbH & Co., KG, Kiel, Germany) for a total of two weeks. After that the engine injection system was disassembled and checked with regard to wear and deposits. It was found that the wear and deposits were in a range comparable to the range found in a corresponding operation with diesel fuel, such that the disclosed ethanol-based fuel is an adequate replacement for diesel fuel not causing any adverse effects concerning the engine.

### EXAMPLE 2

### Switching Over a Self-Ignition Internal Combustion Engine from Operation with Diesel Fuel to Operation with Pyrolysis Oil with an Ethanol-Based Fuel According to the Present Disclosure as Switch Over Fuel

The ethanol-based fuel used as switch over fuel consists of the above-mentioned Bioethanol and Castor Oil commercial grade in a mixing ratio of 50% by volume ethanol and 50% by volume castor oil. Furthermore, diesel fuel according to DIN EN 590 and, as pyrolysis oil, pyrolysis oil supplied by ENSYN, Canada, are used.

An M43 medium speed diesel engine (supplied by Caterpillar Motoren GmbH & Co., KG, Kiel, Germany) is first operated with diesel fuel. Then, a switch over process is carried out by adding the above-mentioned ethanol-based fuel to the diesel fuel in a gradual manner, wherein the amount of the ethanol-based fuel is increased, until the diesel fuel is fully replaced by said ethanol-based fuel. Then, pyrolysis oil was mixed into the ethanol-based fuel, by which the engine is transiently operated, wherein the amount of pyrolysis oil is gradually increased, until the ethanol-based fuel is fully replaced by the pyrolysis oil, and the engine is finally operated with pyrolysis oil only. After one hour of pyrolysis oil operation, the engine and the associated system parts (including ducts and pipes) are disassembled and checked with regard to precipitation products. However, no precipitation products are found in the engine and the associated system parts showing that the disclosed ethanol-based fuel can be suitably used as switch over fuel.

COMPARATIVE EXAMPLE

### Switching Over a Self-Ignition Internal Combustion Engine from Operation with Diesel Fuel to Operation with Pyrolysis Oil Without Switch Over Fuel

Example 2 is essentially repeated, however, switching over from diesel fuel operation to pyrolysis oil operation is carried out without using a switch over fuel. In particular, a switch over process is carried out by adding the above-mentioned pyrolysis oil to the diesel fuel in a gradual manner, wherein the amount of the pyrolysis oil is increased, until the diesel fuel is fully replaced by pyrolysis oil. After one hour of pyrolysis oil operation, the engine and the associated system parts (including ducts and pipes) are disassembled and checked with regard to precipitation products. A large amount of precipitation products are found in particular in the associated system parts, which would adversely affect the operability of the engine and the associated systems parts in the long run.

Although the preferred embodiments of this invention have been described herein, improvements and modifications may be incorporated without departing from the scope of the following claims.

1. An ethanol-based fuel, consisting of 40 to 90% by volume ethanol and 60 to 10% by volume castor oil, and including at least one additive in a total amount of up to 10 wt.-% of the total weight of the ethanol and castor oil.

2. The fuel of claim 1, wherein the ethanol content is 70 to 90% by volume and the castor oil content is 30 to 10% by volume.

3. The fuel of claim 1, wherein the ethanol content is 80 to 90% by volume and the castor oil content is 20 to 10% by volume.

4. The fuel of claim 1, wherein the ethanol content is 85 to 90% by volume and the castor oil content is 15 to 10% by volume.

5. The fuel of claim 1, wherein the ethanol content is 40 to 80% by volume and the castor oil content is 60 to 20% by volume.

6. The fuel of claim 1, wherein the ethanol content is 45 to 65% by volume and the castor oil content is 55 to 35% by volume.

7. The fuel of claim 1, wherein the ethanol content is 45 to 55% by volume and the castor oil content is 55 to 45% by volume.

8. The fuel of claim 1, wherein the ethanol content is 48 to 52% by volume and the castor oil content is 52 to 48% by volume.

9. The fuel of claim 1, wherein the ethanol content is 50% by volume and the castor oil content is 50% by volume.

10. The fuel of claim 1, wherein the at least one additive is selected from the group consisting of thermal stabilizers, aging stabilizers, antioxidants, coloring agents, dyes, odor modifying agents, rust inhibitors, inhibitors of gum formation, metal deactivators, upper cylinder lubricants, friction modifiers, detergents, bacteriostatic agents, fungicides, microbiocides, and mixtures thereof, and wherein the at least one additive is included in a total amount of up to 5 wt.-% of the total weight of the ethanol and castor oil.

11. A method of operating an internal combustion engine, comprising:
switching over operation of the internal combustion engine between operation with a pyrolysis fuel and operation with a crude oil-based fuel by continuously operating the internal combustion engine during the switching over operation with an ethanol-based fuel, the ethanol-based fuel consisting of, 40 to 90% by volume ethanol and 60 to 10% by volume castor oil, and including at least one additive in a total amount of up to 10 wt.-% of the total weight of the ethanol and castor oil.

12. The method of claim 11, wherein the crude oil-based fuel is selected from the group consisting of diesel fuel, light fuel oil, and heavy fuel oil.

13. The method of claim 11, wherein the crude oil-based fuel is diesel fuel.

14. The method of claim 11, wherein the internal combustion engine is a self-ignition internal combustion engine.

15. The method of claim 11, wherein the ethanol content of the ethanol-based fuel is 70 to 90% by volume and the castor oil content is 30 to 10% by volume.

16. The method of claim 11, wherein the ethanol content of the ethanol-based fuel is 80 to 90% by volume and the castor oil content is 20 to 10% by volume.

17. The method of claim 11, wherein the ethanol content of the ethanol-based fuel is 85 to 90% by volume and the castor oil content is 15 to 10% by volume.

18. The method of claim 11, wherein the ethanol content of the ethanol-based fuel is 40 to 80% by volume and the castor oil content is 60 to 20% by volume.

19. The method of claim 11, wherein the ethanol content of the ethanol-based fuel is 45 to 65% by volume and the castor oil content is 55 to 35% by volume.

20. The method of claim 11, wherein the ethanol content of the ethanol-based fuel is 45 to 55% by volume and the castor oil content is 55 to 45% by volume.

21. The method of claim 11, wherein the ethanol content of the ethanol-based fuel is 48 to 52% by volume and the castor oil content is 52 to 48% by volume.

22. The method of claim 11, wherein the ethanol content of the ethanol-based fuel is 50% by volume and the castor oil content is 50% by volume.

23. The method of claim 11, wherein the at least one additive is selected from the group consisting of thermal stabilizers, aging stabilizers, antioxidants, coloring agents, dyes, odor modifying agents, rust inhibitors, inhibitors of gum formation, metal deactivators, upper cylinder lubricants, friction modifiers, detergents, bacteriostatic agents, fungicides, microbiocides, and mixtures thereof, and wherein the at least one additive is included in a total amount of up to 5 wt.-% of the total weight of the ethanol and castor oil.
